(19) United States
(12) Patent Application Publication
(10) Pub. No.: US 2011/0227303 A1
(43) Pub. Date: Sep. 22, 2011

(54) Creeper with LED lights

(76) Inventor: Howard Lawrence Gering, North Caldwell, NJ (US)

(21) Appl. No.: 13/064,345

(22) Filed: Mar. 21, 2011

Related U.S. Application Data
(60) Provisional application No. 61/344,186, filed on Jun. 7, 2010.
(60) Provisional application No. 61/282,707, filed on Mar. 19, 2010.

(51) Int. Cl. F21L 4/02; B62B 11/00; F21V 33/00; F21L 4/08

(52) U.S. Cl. 280/32.6; 362/234; 362/183; 362/184

(57) ABSTRACT

The invention is directed to a creeper having a plurality of LED lights. The LED lights may be housed in a movable member adjacent the creeper frame or in the creeper frame.

### RELATED APPLICATIONS

This application hereby claims the benefit under 35 U.S.C. §119(e) of Provisional Application Ser. No. 61/282,707, filed Mar. 19, 2010, entitled CREEPER WITH LED LIGHTS, and Provisional Application Ser. No. 61/344,186, filed Jun. 7, 2010, entitled CREEPER WITH LED LIGHTS, which applications are incorporated herein by reference in their entireties

### FIELD OF INVENTION

The present invention relates to creepers for permitting mechanics to work on the undercarriage of automotive vehicles and the like. More particularly, the invention relates to creepers with LED lights.

### BACKGROUND OF THE INVENTION

Creepers are well-known in the art, including as disclosed in the E-Z Red Company's U.S. Pat. No. 6,059,298. Creepers are used for, among other things, mechanics working on the undercarriage of automotive vehicles. When working on the undercarriage of a vehicle, light is required for the mechanic to see what he is doing. Trouble lights have been used in the past to illuminate the work area. Additionally, creepers are known having lights such as disclosed in U.S. Pat. Nos. 2,291,094; 4,986,558; 5,330,211; 5,897,122; 6,238,069; 6,540,378; 7,032,907; 7,032,908; and 7,367,570, and U.S. Patent Publications US 2006/0186619 and US 2006/0028819. However, these creepers do not use LED lights and the light devices on the creepers are complex and/or do not provide appropriate lighting to the work area. Additionally, Fuyang Youlian Plastic Co. Ltd. apparently makes a creeper having a single LED light. Again, this creeper does not provide optimal light for the mechanic or other user.

Accordingly, there is a need in the industry for a creeper of simple and inexpensive construction and which provides optimal light to the mechanic or other user to illuminate the work area. The present invention addresses the shortcomings of the prior art creepers.

### SUMMARY OF THE INVENTION

A primary object of the present invention is to provide a creeper with LED lights.

Another primary object of the invention is to provide a creeper having LED lights in a movable member to adjust the lighting on the work area.

Another primary object of the invention is to provide a creeper having LED lights in a movable member which may be removed from the creeper to allow the user to hold the member with the LED lights and provide light to the work area.

Another primary object of the invention is to provide a creeper with LED lights and having a rechargeable battery pack.

Another object of the invention is to provide a creeper having LED lights and one or more tool carriers.

Another object of this invention is to provide a creeper having LED lights and additional accessories, including speakers, magnetic rails, a USB port, Bluetooth telephone capability, and/or input jacks for a music player and headsets therefor.

The creeper of the present invention comprises a frame having side rails and transverse bracing straps, caster wheels connected to the frame, a cushion, and a plurality of LED lights in one or more movable members adjacent the side rails of the creeper. The creeper may further optionally include one or more tool carriers which may be removable from the creeper. The creeper may be foldable and may include an adjustable head support.

The creeper of the present invention further comprises a frame having side rails and transverse bracing straps, caster wheels connected to the frame, a cushion, and a plurality of LED lights in one or more of the side rails of the creeper. Additionally, the invention comprises the aforesaid creeper including a rechargeable battery pack positioned inside or adjacent to one of the transverse bracing straps. The battery pack may further include a charging port to charge the battery.

Additionally, the creeper invention may include additional accessories as discussed hereafter.

These and other objects of the invention will be apparent from the following description of the preferred embodiments of the invention and from the accompanying drawings.

### BRIEF DESCRIPTION OF THE DRAWINGS

The following detailed description of specific non-limiting embodiments of the present invention can be best understood when read in conjunction with the following drawings, where like structures are indicated with like reference numbers.

Referring to the drawings:

FIG. 1 is a top perspective view of the creeper of the invention;

FIG. 2 is a partial side view of the creeper of FIG. 1 showing movement in phantom lines of a member having LED lights and an adjustable head support;

FIG. 3 is a partial side view of the creeper of FIG. 1 showing the movable head support adjusted in an upward position;

FIG. 4 is an end view of the creeper of FIG. 1;

FIG. 5 is a side view of the creeper of FIG. 1 in a folded position;

FIG. 6 is a top partial perspective view of the creeper of FIG. 1 illustrating a movable member with the LED lights;

FIG. 7 is a partial perspective view of the creeper of FIG. 1 illustrating the LED lights in an adjusted position; and

FIG. 8 is a partial top perspective view of another embodiment of the invention.

### DETAILED DESCRIPTION OF THE PREFERRED EMBODIMENTS

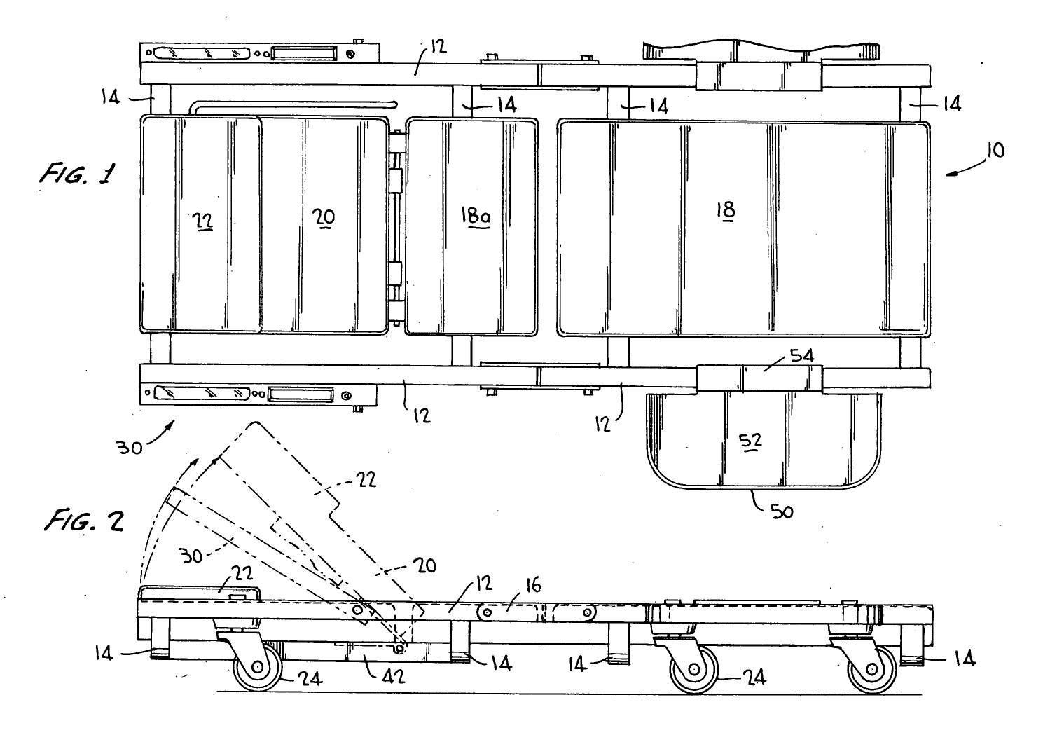

Referring to FIGS. 1-8, the present invention relates to a creeper 10 having LED lights. One embodiment of the invention is shown in FIGS. 1-7 and another embodiment is shown in FIG. 8. The creeper 10 includes a frame having side rails 12 and transverse bracing straps 14. The frame is preferably made of metal but may be made of other materials without departing from the scope of the invention. Additionally, the number of bracing straps is optional and may include more or less than the four disclosed in the embodiment in FIG. 1. The frame members 12 may include hinges 16 allowing the creeper to fold when not in use or for storage as shown in FIG. 5. In the alternative, the creeper may include frame members 12 without hinges and which does not fold.

Creeper 10 further includes a cushion for the body and, in the preferred embodiment, includes a body cushion 18 and 18a and a head support cushion 20. The head support cushion 20 includes an elevated head rest 22. Additionally, the body cushion and head support cushion may include memory foam for additional comfort to the user. The body cushion and/or the head support cushion may further include heating and/or cooling means. For example, these cushions may include means for inserting a cooling pad for providing a cooler temperature to the cushions and/or heating coils for providing heat to the cushions.

The creeper further includes a plurality of caster wheels 24. The preferred embodiment includes six caster wheels 24 although a different number of wheels may be used. The caster wheels 24 are attached to frame 12 by any suitable means such as screws extending through frame 12. The caster wheels are configured on the frame 12 such that they are offset from one another when in the folded position as shown in FIG. 5.

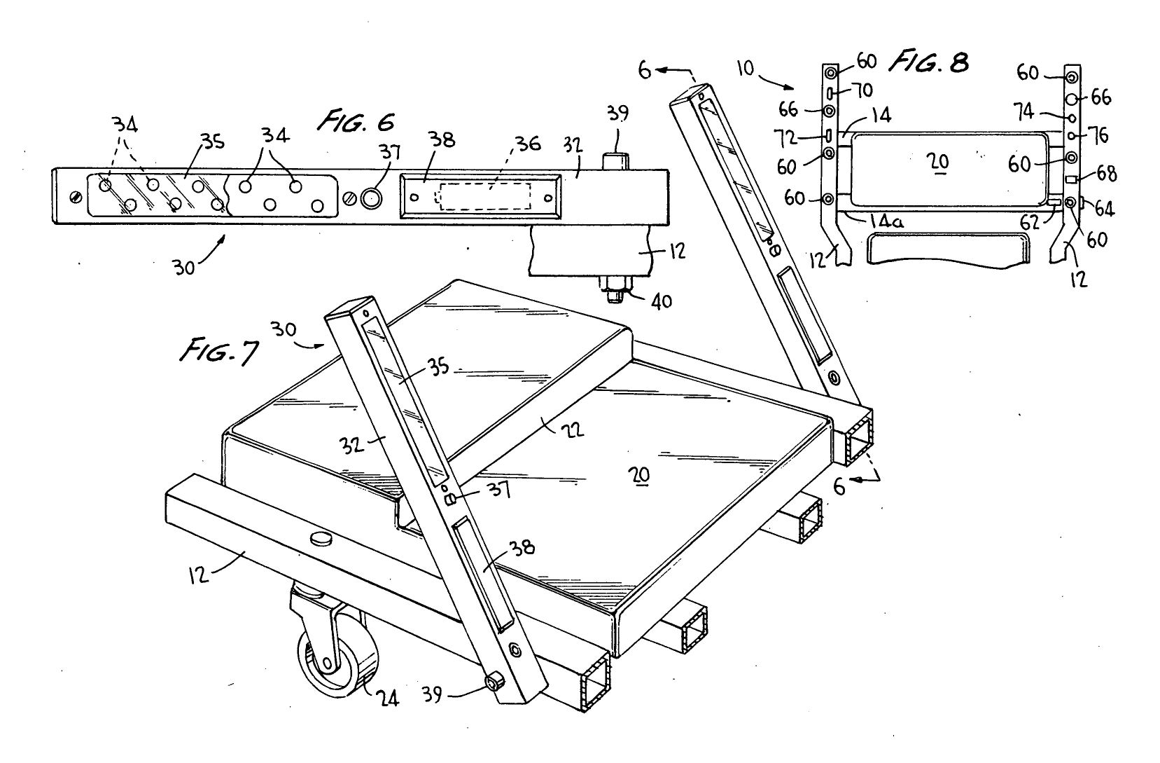

Referring to the creeper in FIGS. 1-7, the creeper includes LED light members 30. The LED light members 30 comprise a housing 32 having a plurality of LED lights 34, in a preferred embodiment 10 lights in two rows, a protective lens cover 35, a battery 36 for powering the LED lights and an on/off switch 37 to turn the LED lights on and off. The battery 36 is located in housing 32 and connected to a LED light panel having the LED lights 34 as known to one skilled in the art. The battery is accessed through cover 38. The housing 32 is movable and is secured to rail 12 by adjustable means such as bolt 39 and nut 40. The LED light members 30 may be in adjacent horizontal relation to rail 12 as shown in FIG. 1 or may move as shown in FIGS. 2 and 7 to adjust the focus of the light on the work object. Additionally, while not shown, the LED light members 30 may be removable from the frame 12 to allow the worker to hold the light to focus the light on the work area.

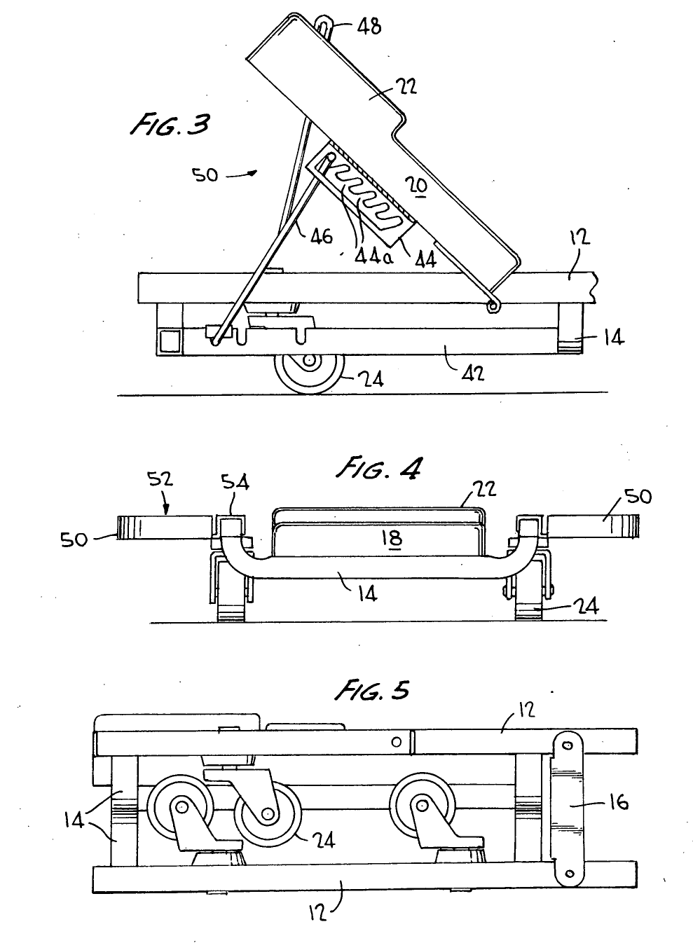

As previously stated, the creeper further includes an adjustable head support 20. The adjustable head support is best shown in FIG. 3 and includes two support braces 42 connected at each end to bracing straps 14. The adjustment means includes a bracket 44 having a plurality of recesses 44a and positioning arm 46 to adjust the height of the head support with handle 48.

Additionally, the creeper 10 may include one or more tool carriers 50 as best shown in FIGS. 1 and 4. The carriers 50 may include a recessed portion 52 for receiving and holding tools or other items. The tool carriers are removably attached to rail 12 by an inverted U-shaped bracket 54. The tool carriers may be removed from the creeper when not needed or when folding the creeper for storage.

Another embodiment of the creeper 10 is shown in FIG. 8. Creeper 10 in this embodiment includes side rails 12 having recessed portions therein near the head support for receiving a plurality of LED lights 60. In this embodiment, each side rail 12 includes three LED lights. However, it is understood that the side rails may include a different number of LED lights without departing from the scope of the invention. Transverse bracing strap 14a includes inside the bracing strap a rechargeable battery pack 62 for powering the LED lights. The battery pack is connected to the LED lights 60 through any suitable electrical connecting means such as wires (not shown) running through the inside of the creeper frame. While in the preferred embodiment the battery pack 62 is at least partially enclosed inside the bracing strap 14, the battery pack may be connected adjacent to the bracing strap or otherwise located on the creeper without departing from the scope of the invention. The battery pack further includes a charging port 64 for charging the battery pack.

FIG. 8 also illustrates that additional accessories may be included on the creeper including one or more speakers 66 which may be connected to any suitable music source or other source of entertainment such as an MP3 music player. Magnetic strips (not shown) may be included in frame 12 for holding objects such as screws or other items. Additionally, the creeper may include a USB port 68 which is connected to the battery 62 and may be used as a power supply for various devices, including an iPod, Blackberry, MP3 player or the like. Additionally, the creeper may include a Bluetooth telephone port 70 and microphone 72 for cellular telephone use and playing music through the Bluetooth system. Additionally, the creeper may include a 3.5 mm input jack 74 for receiving the plug for a music player and a 3.5 mm headset jack 76 for a headset for listening to music. It is understood that the creeper may include one or more of these accessories or may include the accessories alone without other features of the invention.

Various size creepers may be used. However, in the preferred embodiment, the approximate size of the creeper is in the range of 20 to 32 inches in width and 40 to 45 inches in length.

The exemplary embodiments disclosed herein are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claim.

It is claimed:

1. A creeper having LED lights comprising a frame having side rails, at least one movable member attached to one of said side rails, said movable member including a plurality of LED lights.

2. A creeper according to claim 1 wherein said movable member comprises a housing, said housing including a plurality of LED lights, a power source for powering said LED lights and an on-off button.

3. A creeper according to claim 2 wherein said creeper includes two movable members, each movable member attached to a respective side rail of said creeper.

4. A creeper according to claim 3 wherein said movable members are attached to said side rails by a nut and bolt fastening means constructed and arranged to allow movement of said movable members, wherein said movement allows for the adjustment of the light on a work area.

5. A creeper according to claim 2 wherein said power source comprises a battery.

6. A creeper according to claim 5 wherein said battery is a rechargeable battery.

7. A creeper according to claim 1 wherein said frame is a foldable frame.

8. A creeper according to claim 1 further including a body cushion and a head support cushion, wherein said creeper includes a means for adjusting the height of said head support cushion.

9. A creeper according to claim 3 wherein said creeper includes at least one tool carrier removably attached to one of said side rails.

10. A creeper according to claim 9 wherein said tool carrier includes an inverted U-shaped member for removably attaching said tool carrier to said frame.

11. A creeper according to claim 3 wherein said creeper includes optional accessories selected from the group consisting of speakers, a USB port, a Bluetooth port, a headset jack, an input jack for a music player and a microphone.

12. A creeper having LED lights comprising a frame having side rails and at least one transverse bracing strap, said side rails having a plurality of recessed portions having LED lights positioned therein and said transverse bracing strap having a battery pack positioned therein and connected to said LED lights.

13. A creeper according to claim 12 wherein said battery pack is a rechargeable battery pack.

14. A creeper according to claim 12 wherein said frame is a foldable frame.

15. A creeper according to claim 12 further including a body cushion and a head support cushion, wherein said creeper includes a means for adjusting the height of said head support cushion.

16. A creeper according to claim 12 wherein said creeper includes at least one tool carrier removably attached to one of said side rails.

17. A creeper according to claim 16 wherein said tool carrier includes an inverted U-shaped member for removably attaching said tool carrier to said frame.

18. A creeper according to claim 13 wherein said creeper includes optional accessories selected from the group consisting of speakers, a USB port, a Bluetooth port, a headset jack, an input jack for a music player and a microphone.
